(19) United States
(12) Patent Application Publication
(10) Pub. No.: US 2016/0049877 A1
(43) Pub. Date: Feb. 18, 2016

(54) INDUCTANCE VARYING CIRCUIT AND POWER SUPPLY APPARATUS INCLUDING THE SAME

(71) Applicants: SAMSUNG ELECTRO-MECHANICS CO., LTD., Suwon-Si (KR); Korea Advanced Institute of Science and Technology, Daejeon (KR)

(72) Inventors: Jung Min KANG, Suwon-Si (KR); Gun Woo MOON, Daejeon (KR); Yeon Ho JEONG, Suwon-Si (KR); Jae Kuk KIM, Suwon-Si (KR); Jae Hyun KIM, Daejeon (KR)

(73) Assignees: SAMSUNG ELECTRO-MECHANICS CO., LTD., Suwon-Si (KR); Korea Advanced Institute of Science and Technology, Daejeon (KR)

(21) Appl. No.: 14/615,413

(22) Filed: Feb. 5, 2015

(30) Foreign Application Priority Data
Aug. 18, 2014 (KR) 10-2014-0107099

(51) Int. Cl. H02M 3/335

(52) U.S. Cl. CPC H02M 3/33546

(57) ABSTRACT

A power supply apparatus may include a transformer unit outputting a voltage transformed depending on an inductance ratio between a primary side and a secondary side, an inductance varying unit varying an inductance of the primary side depending on whether or not external input power is being input, and an output unit stabilizing the transformed voltage and outputting the stabilized voltage.

### CROSS-REFERENCE TO RELATED APPLICATION

This application claims the priority and benefit of Korean Patent Application No. 10-2014-0107099, filed on Aug. 18, 2014, with the Korean Intellectual Property Office, the disclosure of which is incorporated in its entirety herein by reference.

### BACKGROUND

Some embodiments of the present disclosure may relate to an inductance varying circuit and a power supply apparatus including the same.

A power supply apparatus may perform transformation of voltages using a transformer to provide the voltage required by a load. The power supply apparatus may need to stably supply a voltage for a predetermined period of time or more even in the variations of an external input voltage for the purpose of protection of the load, or the like.

A power storing element such as a capacitor, or the like, may be used in order to stably supply a voltage for a predetermined period of time or longer, even in the case when the supply of the external input power stops. However, in the case of using the power storing element as described above, a size of the power storing element may be increased for the purpose of stable operations, such that a size of the power supply apparatus may be increased.

Japanese Patent Laid-Open Publication No. 2006-020467 and Japanese Patent Laid-Open Publication No. 2000-114076 may be referred to figure out the related art.

[Related Art Document]

(Patent Document 1) Japanese Patent Laid-Open Publication No. 2006-020467

(Patent Document 2) Japanese Patent Laid-Open Publication No. 2000-114076

### SUMMARY

An aspect of the present disclosure may provide a power supply apparatus capable of stably outputting a voltage for a sufficient period of time, even in the case when the supply of external input power stops.

According to an aspect of the present disclosure, a power supply apparatus may include: a transformer unit outputting a voltage transformed depending on an inductance ratio between a primary side and a secondary side; an inductance varying unit varying an inductance of the primary side depending on whether or not external input power is being input; and an output unit stabilizing the transformed voltage and outputting the stabilized voltage.

In the summary, all of features of the present disclosure are not mentioned. Various means for solving an object of the present disclosure may be understood in more detail with reference to specific exemplary embodiments of the following detailed description.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a configuration diagram illustrating a power supply apparatus according to an exemplary embodiment of the present disclosure;

FIG. 2 is a graph illustrating a change in gain characteristics depending on a switching frequency;

FIG. 3 is a configuration diagram illustrating a power supply apparatus according to another exemplary embodiment of the present disclosure;

FIG. 4 is a configuration diagram illustrating a power supply apparatus according to another exemplary embodiment of the present disclosure;

FIG. 5 is a perspective view illustrating an example of a winding and a core that may be applied to an inductance varying circuit;

FIG. 6 is a perspective view illustrating another example of a winding and a core that may be applied to an inductance varying circuit;

FIGS. 7A and 7B are graphs for comparing lengths of holdup times of related art and an embodiment of the present disclosure; and

FIG. 8 is a graph illustrating efficiency in an entire load range.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

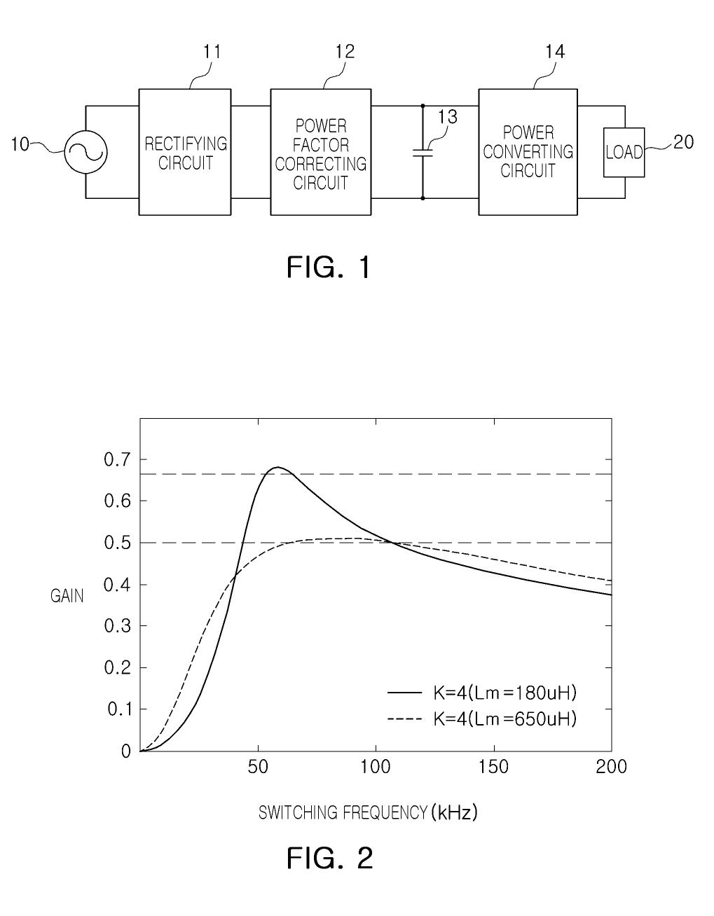

FIG. 1 is a configuration diagram illustrating a power supply apparatus according to an exemplary embodiment of the present disclosure.

Referring to FIG. 1, a power supply apparatus according to an exemplary embodiment of the present disclosure may include a link capacitor 13 and a power converting circuit 14. According to the exemplary embodiment, the power supply apparatus may further include a rectifying circuit 11 and a power factor correcting circuit 12.

The rectifying circuit 11 may rectify external input power 10 and transfer the rectified power to the power factor correcting circuit 12. According to an exemplary embodiment, the rectifying circuit 11 may further include, for example, but not limited to, a smoothing circuit to rectify and smooth input AC power.

The power factor correcting circuit 12 may correct a power factor, for instance, by adjusting a phase difference between a voltage and a current of the power rectified by the rectifying circuit 11, but not limited thereto. The power factor correcting circuit 12 may also correct the power factor by adjusting a current waveform of the rectified power so as to follow a voltage waveform.

The link capacitor 13 may store or charge a predetermined voltage therein. The voltage stored in the link capacitor 13 may be used in the case in which the supply of the external input power 10 stops. That is, the power supply apparatus may be required to stably supply a voltage for a predetermined period of time (holdup time) or more even after the supply of the externally input power 10 stops, and the link capacitor 13 may be used as a power supply source in the case in which the supply of the external input power 10 stops, as described above.

The power converting circuit 14 may convert a voltage level of the power provided from the external input power 10 or the link capacitor 13. Hereinafter, various examples of the power supply apparatus will be described, and the power converting circuit 14 will be mainly described in describing various examples of the power supply apparatus. Therefore, hereinafter, the power supply apparatus will be generally called the power converting circuit for illustration purposes only.

As described above, the power supply apparatus may be required to stably supply the power for a predetermined period of time or more even when or after the supply of the external input power 10 stops. The predetermined period of time may be called a holdup time.

To provide the sufficient holdup time, a capacitance value of the link capacitor 13 may be increased. However, this may not help miniaturization of products and an increase in density of the products.

Therefore, the power supply apparatus according to an exemplary embodiment of the present disclosure may apply different inductances in a normal state and during the holdup time to thereby stably operate even in the normal state and sufficiently satisfy or provide the holdup time.

That is, in an exemplary embodiment of the present disclosure, one or more inductances may be variably set to variably set an input range, that is, a gain range, of the power supply apparatus.

$$[ Mathematical Equation 1 ] \\ Gain = \frac{{nV}_{o}}{{V}_{i n}} = ( \frac{1}{2 \cdot \sqrt{{\{ 1 + \frac{1}{K} [ 1 - {( \frac{{f}_{r}}{{f}_{s}} )}^{2} ] \}}^{2} + {[ \frac{{π}^{2}}{8 {n}^{2}} \cdot Q ( \frac{{f}_{s}}{{f}_{r}} - \frac{{f}_{r}}{{f}_{s}} ) ]}^{2}}} ) \qquad$$

Here, fr refers to a resonant frequency and fs refers to a switching frequency.

Mathematical Equation 1 may be an equation for calculating a gain curve, and FIG. 2 is a graph illustrating a change in gain characteristics depending on a switching frequency.

Referring to Mathematical Equation 1 and FIG. 2, a gain of 0.5 may be appropriate in a state in which the external input power is normally provided, that is, the normal state, and a gain of 0.675 denoted by a solid line maybe appropriate in order to stably supply the power in the holdup time.

The change in the gain may be accomplished by changing a K value in Mathematical Equation 1. The K value may be represented by a ratio of inductors of the power supply apparatus. For instance, the power supply apparatus having a small K value may obtain a high gain.

However, the small K value may mean a small value of a magnetizing inductance, which may require an increase in a primary side conduction current. Therefore, although the embodiment of the power supply apparatus having the small K value may sufficiently provide the holdup time, the primary side conduction current may be increased, such that converting efficiency may be decreased.

Therefore, the power supply apparatus according to an exemplary embodiment of the present disclosure may variably set the gain depending on whether or not the external input voltage is provided. That is, the power supply apparatus according to the exemplary embodiment of the present disclosure may accomplish high efficiency in the normal state and vary an inductance so as to operate in a wide input range in the holdup time.

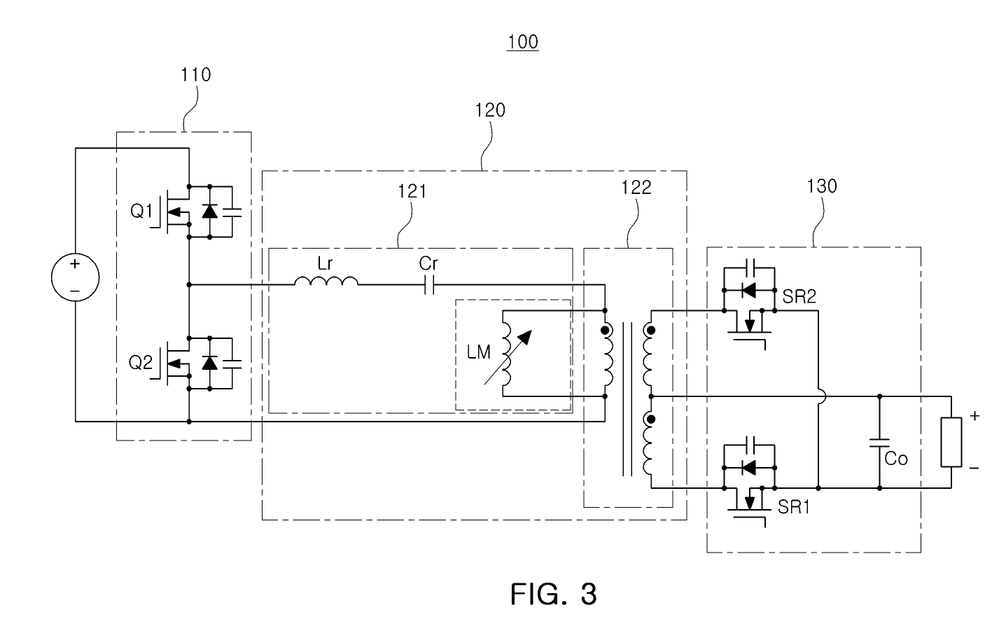

Hereinafter, various examples of a power supply apparatus according to exemplary embodiments of the present disclosure will be described with reference to FIGS. 3 through 6.

FIG. 3 is a configuration diagram illustrating a power supply apparatus according to an exemplary embodiment of the present disclosure.

Referring to FIG. 3, the power supply apparatus 100 may include a switch unit 110 and a transformer unit 120. According to the exemplary embodiment, the power supply apparatus 100 may further include an output unit 130.

The switch unit 110 may include at least two switches stacked between an input power terminal to which the external input power is input and a ground. In the example illustrated in FIG. 3, the switch unit 110 may include a pair of switches Q1 and Q2 and perform a power conversion operation by an alternate switching operation of the first and second switches Q1 and Q2.

The transformer unit 120 may output a voltage transformed depending on an inductance ratio between a primary side and a secondary side.

The transformer unit 120 may include a variable inductor disposed on the primary side and providing a variable inductance.

The transformer unit 120 may include a resonant tank 121 and a transformer 122. The resonant tank 121 may include a variable inductor Lm.

In the exemplary embodiment, the variable inductor Lm may have a first inductance value in a state in which the external input power is normal and a second inductance value smaller than the first inductance value in a state in which the supply of the external input power stops.

The resonant tank 121 may include, for instance, but not limited to, an inductor-capacitor LC resonant circuit or an inductor-inductor-capacitor LLC resonant circuit. In the example illustrated in FIG. 3, the resonant tank 121 may include an inductor Lr, an inductor Lm, and a capacitor Cr. Here, a magnetizing inductor of the transformer 122 may be configured of the variable inductor Lm.

The transformer 122 may transform a voltage depending on a ratio of a secondary winding to a primary winding.

The output unit 130 may stabilize the voltage transformed and output by the transformer unit 120 and output the stabilized voltage.

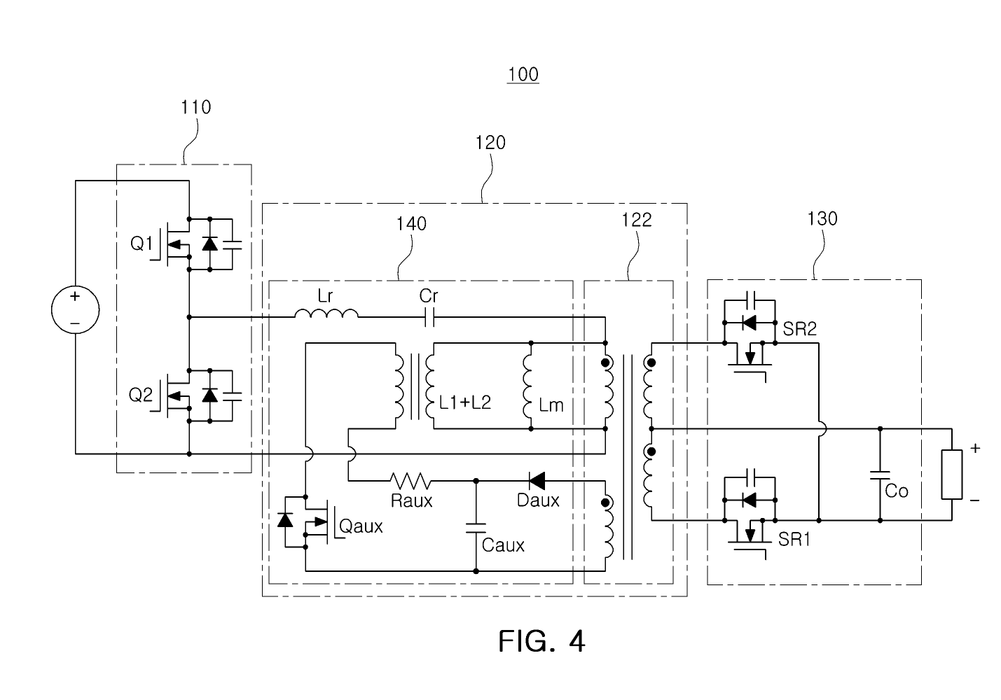

FIG. 4 is a configuration diagram illustrating a power supply apparatus according to another exemplary embodiment of the present disclosure. In the power supply apparatus according to another exemplary embodiment of the present disclosure illustrated in FIG. 4, an inductance varying circuit 140 may be used instead of the variable inductor used in the power supply apparatus according to the exemplary embodiment of the present disclosure illustrated in FIG. 3.

Referring to FIG. 4, the power supply apparatus 100 may include a transformer unit 120 and an inductance varying unit 140. According to the exemplary embodiment, the power supply apparatus 100 may further include an output unit 130.

The transformer unit 120 may output a voltage transformed depending on an inductance ratio between a primary side and a secondary side.

The inductance varying unit 140 may vary an inductance of the primary side depending on whether or not the external input power is being input. For example, the inductance varying unit 140 may be implemented as a separate circuit, but not limited thereto . In this case, the inductance varying unit 140 may be called an inductance varying circuit.

In an exemplary embodiment, the inductance varying unit 140 may determine and/or change an inductance value of the primary side to be a first inductance value in a state in which the external input power is normal, and determine the inductance value of the primary side to be a second inductance value smaller than the first inductance value in a state in which the supply of the externally input power stops.

In an exemplary embodiment, the inductance varying unit 140 may determine a gain value of the primary side to be a first gain value in the state in which the externally input power is normal and determine the gain value of the primary side to be a second gain value larger than the first gain value in the state in which the supply of the externally input power is stopped.

The inductance varying unit 140 may include an auxiliary winding and a bias circuit. Although the case in which the inductance varying unit 140 includes auxiliary windings L1 and L2 has been illustrated in FIG. 4 as an example, the number of auxiliary windings may be changed.

A primary winding Lm may have an appropriate or predetermined inductance value in the normal state. For instance, in the normal state, a switch Qaux may be in a turn-off state, such that a magnitude of a primary side magnetizing current of the power supply apparatus 100 may be decreased to increase efficiency.

Meanwhile, for the holdup time, the switch Qaux may be turned on to vary the inductance. In the example illustrated in FIG. 4, it may be appreciated that the varied inductance corresponds to a value of Lm/(L1+L2). That is, as described above, the power supply apparatus 100 may have a small K value for the holdup time to obtain a high gain, thereby providing a stable output for the holdup time.

In an exemplary embodiment, the inductance varying unit 140 may include one auxiliary winding. The inductance varying unit 140 may include a first auxiliary winding connected in parallel with the primary winding and a switch connected to the first auxiliary winding in series . The switch may be switched depending on, for example, but not limited to, a state of the external input power applied to the power supply apparatus.

In another exemplary embodiment, the inductance varying unit 140 may include two auxiliary windings. The inductance varying unit 140 may include a first auxiliary winding connected in parallel with the primary winding, a second auxiliary winding connected to the first auxiliary winding in series, and a switch connected to the first and second auxiliary windings in series .

The switch may be switched depending on, for instance, but not limited to, a state of the external input power applied to the power supply apparatus.

The output unit 130 may stabilize the transformed voltage and output the stabilized voltage.

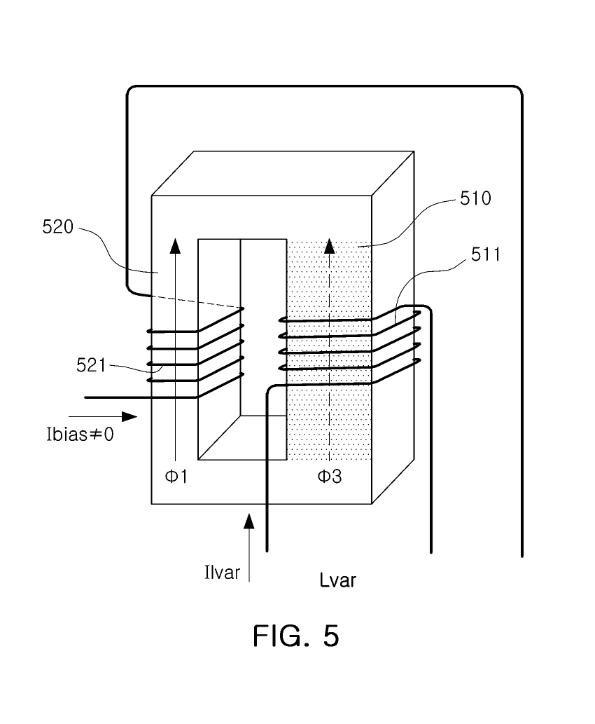

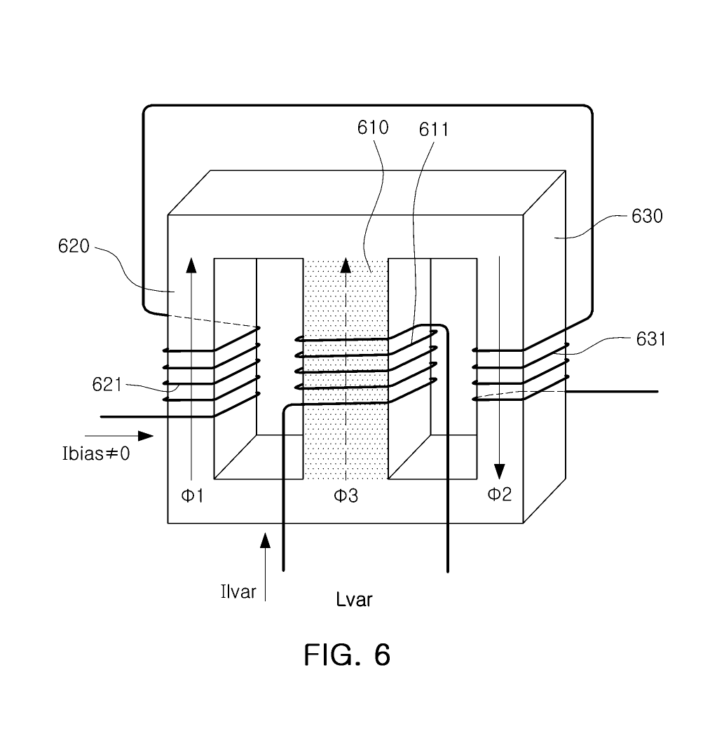

FIGS. 5 and 6 show various examples of a winding structure that may be applied to the inductance varying unit 140.

FIG. 5 is a perspective view illustrating an example of a winding and a core that may be applied to an inductance varying circuit. In FIG. 5, an example in which the inductance varying unit 140 includes one auxiliary winding is illustrated.

Referring to FIG. 5, an auxiliary winding 521 may be wound around a first side leg 520 formed in parallel with a central leg 510 around which a primary winding 511 is wound.

A core illustrated in FIG. 5 may include the central leg 510 and the first side leg 520, and two windings may be wound around a single core, such that miniaturization may be accomplished.

FIG. 6 is a perspective view illustrating another example of a winding and a core that may be applied to an inductance varying circuit. In FIG. 6, an example in which the inductance varying unit 140 includes a pair of auxiliary windings is illustrated.

Referring to FIG. 6, a first auxiliary winding 621 may be wound around a first side leg 620 formed in parallel with a central leg 610 around which a primary winding 611 is wound.

A second auxiliary winding 631 may be connected to the first auxiliary winding 621 in series. The second auxiliary winding 631 may be wound around a second side leg 630 formed in parallel with the central leg 610 and/or the first side leg 620. The central leg 610 may form, together with the first and second side legs 620 and 630, a single core.

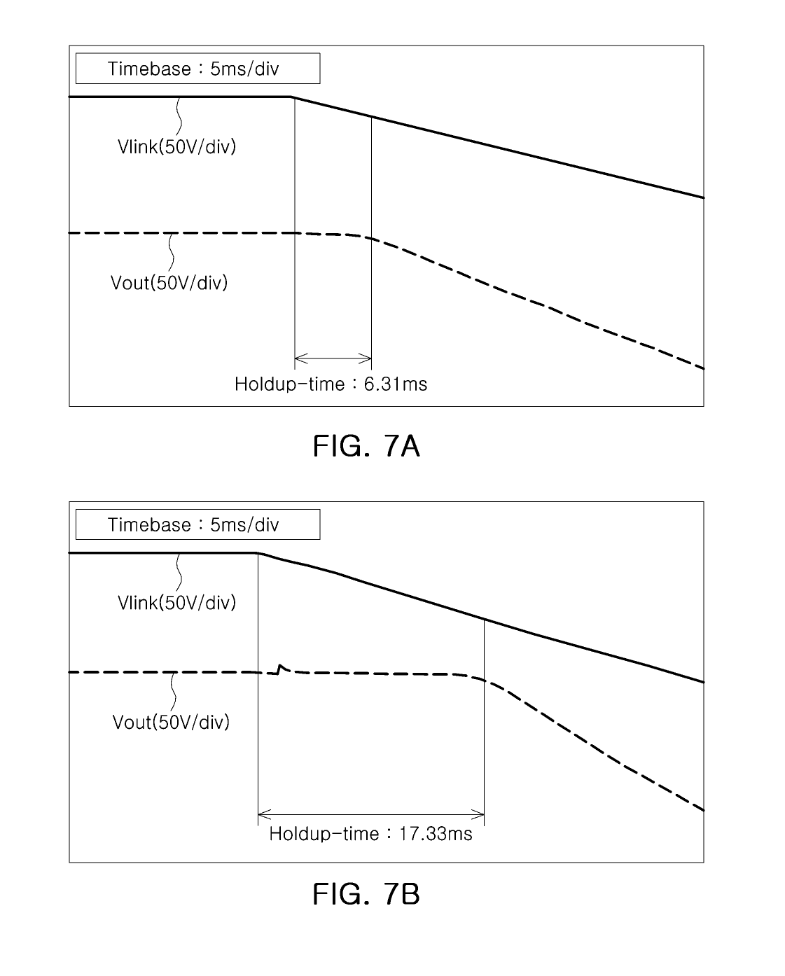

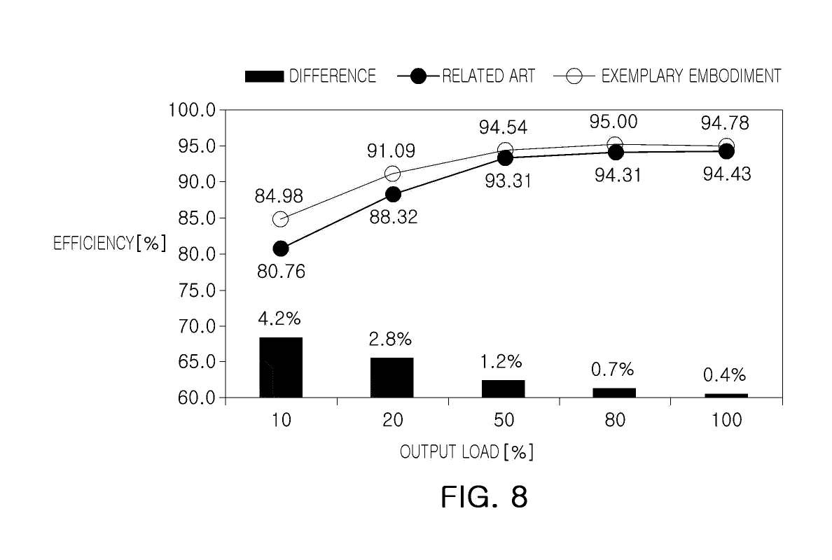

FIGS. 7A and 7B are graphs for comparing lengths of holdup times with each other; and FIG. 8 is a graph illustrating efficiency in an entire load range.

FIG. 7A is a graph of a general power supply apparatus according to the related art, and FIG. 7B is a graph of a power supply apparatus according to an exemplary embodiment of the present disclosure.

It may be appreciated from FIGS. 7A and 7B that a maximum holdup time is only 6.31 ms in the related art, while a maximum holdup time is 17.33 ms in an exemplary embodiment of the present disclosure, which is increased as compared with the related art.

In addition, it may be confirmed from FIG. 8 that efficiency is increased in an entire load range and is increased by 4.2% and 2.8% particularly in the loads of 10% and 20%, which are light load regions.

In the power supply apparatus according to some exemplary embodiments of the present disclosure, a requirement for the holdup time may be satisfied and high efficiency in the normal state may be secured without burden in a cost and power density by an additional winding and a simple control.

As set forth above, according to some exemplary embodiments of the present disclosure, a voltage may be stably output for a sufficient period of time even in the case in which the supply of the external input power stops.

While exemplary embodiments have been shown and described above, it will be apparent to those skilled in the art that modifications and variations could be made without departing from the scope of the present invention as defined by the appended claims.

What is claimed is:

1. A power supply apparatus comprising:
a transformer unit outputting a voltage transformed depending on an inductance ratio between a primary side and a secondary side;
an inductance varying unit varying an inductance of the primary side depending on external input power; and
an output unit stabilizing the transformed voltage and outputting the stabilized voltage.

2. The power supply apparatus of claim 1, wherein the inductance varying unit determines an inductance value of the primary side to be a first inductance value in a state in which the external input power is normal and determines the inductance value of the primary side to be a second inductance value smaller than the first inductance value in a state in which supply of the external input power stops.

3. The power supply apparatus of claim 1, wherein the inductance varying unit determines a gain value of the primary side to be a first gain value in a state in which the external input power is normal and determines the gain value of the primary side to be a second gain value larger than the first gain value in a state in which supply of the external input power stops.

4. The power supply apparatus of claim 1, wherein the inductance varying unit includes:
a first auxiliary winding connected to a primary winding in parallel; and
a switch connected to the first auxiliary winding in series.

5. The power supply apparatus of claim 4, wherein the first auxiliary winding is wound around a first side leg formed in parallel with a central leg around which the primary winding is wound.

6. The power supply apparatus of claim 1, wherein the inductance varying unit includes:
a first auxiliary winding connected to a primary winding in parallel;
a second auxiliary winding connected to the first auxiliary winding in series; and
a switch connected to the first and second auxiliary windings in series.

7. The power supply apparatus of claim 6, wherein the first auxiliary winding is wound around a first side leg formed in parallel with a central leg around which the primary winding is wound, and
the second auxiliary winding is wound around a second side leg formed in parallel with the central leg and the first side leg.

8. The power supply apparatus of claim 7, wherein the central leg forms, together with the first and second side legs, a single core.

9. A power supply apparatus comprising:
a transformer unit outputting a voltage transformed depending on an inductance ratio between a primary side and a secondary side; and
an output unit stabilizing the transformed voltage and outputting the stabilized voltage,
wherein the transformer unit includes a variable inductor disposed on the primary side and providing a variable inductance.

10. The power supply apparatus of claim 9, wherein the variable inductor has a first inductance value in a state in which external input power is normal and has a second inductance value smaller than the first inductance value in a state in which supply of the external input power stops.

11. An inductance varying circuit connected to a primary winding of a transformer of a power supply apparatus, the inductance varying circuit comprising:
a first auxiliary winding connected to the primary winding of the transformer in parallel; and
a switch connected to the first auxiliary winding in series,
wherein the switch is switched depending on a state of external input power applied to the power supply apparatus.

12. The inductance varying circuit of claim. 11, wherein the first auxiliary winding is wound around a first side leg formed in parallel with a central leg around which the primary winding is wound.

13. An inductance varying circuit connected to a primary winding of a transformer of a power supply apparatus, the inductance varying circuit comprising:
a first auxiliary winding connected to the primary winding of the transformer in parallel;
a second auxiliary winding connected to the first auxiliary winding in series; and
a switch connected to the first auxiliary winding in series,
wherein the switch is switched depending on a state of external input power applied to the power supply apparatus.

14. The inductance varying circuit of claim 13, wherein the first auxiliary winding is wound around a first side leg formed in parallel with a central leg around which the primary winding is wound, and
the second auxiliary winding is wound around a second side leg formed in parallel with the central leg and the first side leg.
